(19) United States
(12) Patent Application Publication
(10) Pub. No.: US 2002/0177974 A1
(43) Pub. Date: Nov. 28, 2002

(54) Scanning system and method which utilizes continuous motion control and data acquisition triggering

(76) Inventors: Joseph Ting, Austin, TX (US); James Balent, Cedar Park, TX (US); Sundeep Chandhoke, Austin, TX (US)

Correspondence Address: Jeffrey C. Hood, Conley, Rose, & Tayon, P.C., P.O. Box 398, Austin, TX, 78767, US

(21) Appl. No.: 10/090,482

(22) Filed: Mar. 4, 2002

Related U.S. Application Data
(60) Provisional application No. 60/273,211, filed on Mar. 1, 2001.

(51) Int. Cl. G01C 9/00; G06F 15/00; G01C 17/00; G01C 19/00

(52) U.S. Cl. 702/150

(57) ABSTRACT

A motion control system which provides improved scanning of an object is disclosed. The motion control system utilizes motion control and data acquisition devices which communicate through direct hardware triggering to provide improved scanning efficiency. The motion control system may be used in a plurality of various fields, e.g., for general scanning of an object. As one example, the motion control system may be used in the precise alignment of fiber optic components. The motion control system permits arbitrary and continuous motion using hardware triggers to acquire data in an accurate and speedy manner.

### PRIORITY CLAIM

This application claims benefit of priority of U.S. provisional application Serial No. 60/273,211 titled “Scanning System and Method which Utilizes Continuous Motion Control and Data Acquisition Triggering,” filed Mar. 1, 2001, whose inventor was Joseph Ting.

### FIELD OF THE INVENTION

The present invention relates generally to motion control used in scanning a device. More particularly, the present invention relates to a system wherein a data acquisition device and a motion control device coordinate using triggers to more efficiently scan a device.

### DESCRIPTION OF THE RELATED ART

Motion control is a broad term that may be defined as the precise control of anything that moves. A motion system typically comprises five major components: 1) the moving mechanical device; 2) the motor (servo or stepper motor) with feedback and motion I/O; 3) the motor drive unit; 4) the intelligent controller; and 5) the programming/interface software. Scientists and engineers use servo and stepper motors for position and velocity control in a variety of electromechanical configurations.

Prior motion control systems have used proprietary control hardware to control the motion system. These proprietary systems have suffered from high cost and limited flexibility. More recently, computer systems are being used in motion control systems. The computer system may serve as the operator interface or human machine interface (HMI) as well as the local control host in the remote system controller platform. The use of personal computers in motion control is widely accepted and growing at a significant pace. While many motion control solutions today still use standalone distributed motion control and closed architecture systems, computer-based motion solutions provide added flexibility and the potential for lower system cost.

Motion control systems are used in a variety of applications and fields. One particular application of a motion control system is in the field of precision alignment of an optical fiber and a component, e.g., a waveguide filter, collimator, etc. Here an accurate and high resolution alignment is necessary to ensure optimal coupling efficiency and low loss of power. In the rapidly expanding market of fiber optic components, manufacturing processes are typically operated manually or are poorly automated, resulting in high costs and low availability of parts. When manual alignment is used, an operator can spend more than an hour assembling each part, making measurements visually under a microscope and making micromovements of the parts with thumbscrews. As a result, manual manufacturing results in low yields in addition to long, inconsistent cycle times. Computer based motion control may be used to perform precision alignment of an optical fiber and a component, thus improving the manufacturing process of fiber optic components.

Currently, there are a number of automated systems appearing in the marketplace that significantly improve the process over manual assembly. However, these first generation systems still do not provide the degree of precision alignment that is required in fiber optic applications, or otherwise consume large amounts of time to operate. For example, current approaches include: (1) moving to a position, stopping, and taking a measurement; (2) measuring based on estimated position while moving; and (3) triggering a scan clock using an encoder such that movement is limited to one axis at a time. These solutions do not provide an adequate combination of accuracy and speed for many users.

Therefore, an improved system and method is desired for aligning objects, such as fiber optic components.

### SUMMARY OF THE INVENTION

One embodiment of the present invention comprises a system and method which provide improved scanning of an object. The system utilizes a motion control device and a measurement device, e.g., a data acquisition device, that communicate through direct hardware triggering to provide improved scanning efficiency. The system may be used in a plurality of various fields, e.g., for general scanning of an object. As one example, the system may be used in the precise alignment of fiber optic components.

According to one embodiment of the method, the motion control device may be continuously moved. One or more of the object to be scanned and/or a sensor may be coupled to the motion control device, so that continuously moving the motion control device continuously moves the sensor and/or the object to allow the sensor to scan the object. For example, the sensor may acquire any of various types of measurement data from the object.

The measurement device may periodically receive measurement data from the sensor. The measurement data may be received at regular or non-regular intervals. Each time measurement data is received, the measurement device may trigger the motion control device. The measurement device may trigger the motion control device simultaneously when the measurement data is received. In response to each trigger by the measurement device, the motion control device may record its current position. The measurement device may be directly coupled to the motion control device through a dedicated channel to provide real-time triggering or communication between the measurement device and the motion control device. Thus, the motion control device may record its position at substantially the exact time as when the measurement device received the respective measurement data.

The measurement data and the position data may then be correlated to determine scanning information for the object. For example, a computer system may receive measurement data from the measurement device and may receive position data from the motion control device. The computer system may then correlate the measurement data and the position data to determine scanning information for the object.

As noted above, the present invention may be used in any of various applications. In a precision alignment example, the motion control device may be coupled to move one or both of two objects being aligned, e.g., may be coupled to move one or both of two fiber optic components being aligned. A sensor may be coupled to or may sense data regarding one or both of the objects being aligned, e.g., to acquire measurement data indicating the relative alignment of the two objects. The position data and the measurement data may be correlated to determine an aligned position.

In one embodiment, a computer system may include a data acquisition card and a motion control card which are connected through a real time system integration (RTSI) bus. In one embodiment, the data acquisition card and the motion control card are comprised in a PXI chassis and utilize timing and triggering lines comprised in the PXI chassis for real-time communication. In this embodiment, the computer system may be an external system coupled to the PXI chassis, or a “computer on a card” comprised in the PXI chassis.

In a fiber optic precision alignment example, a data acquisition device may be coupled to a sensor which is adapted to measure the intensity of a light beam being generated by one of the fiber optic components in order to enable precision alignment of a second fiber optic component. As the data acquisition device takes measurements of the object, e.g., the intensity of the light beam, the data acquisition device also simultaneously generates a trigger over the communication channel to the motion control device when the measurements occur. In response to this trigger, the motion control device records its position at the exact time (or substantially the exact time) the data acquisition device acquired the measurement. Thus, the motion control device can operate continuously to move the sensor across the object being scanned, e.g., can continuously move one or both of the fiber optic components in a continuous fashion, and when triggers are received the motion control device simply records its position. The data acquisition device may store its measurements in a memory, and the motion control device may store the corresponding positions of the sensor, e.g., of one or both of the fiber optic components, based on received triggers which correspond to when the measurements were taken.

The computer system coupled to the data acquisition device and the motion control device may then receive the recorded measurements from the data acquisition device and the corresponding recorded positions from the motion control device and correlate this information to generate information regarding the intensity measurements taken with respect to the positions recorded. This information can hence be used in various coarse and fine scanning patterns to precisely align two objects such as two fiber optic components. In other applications, the correlated information can be used to more efficiently scan an object for any of various other features of interest.

### BRIEF DESCRIPTION OF THE DRAWINGS

A better understanding of the present invention can be obtained when the following detailed description of the preferred embodiment is considered in conjunction with the following drawings, in which:

FIG. 1 illustrates an example of a system for motion control and measurement including an object being scanned according to one embodiment;

FIG. 2 illustrates an example of a motion control system according to one embodiment;

FIG. 2A illustrates an example of a motion control system having a motion control interface device and a data acquisition device comprised within a computer system according to one embodiment;

FIG. 2B illustrates an example of a motion control system having a motion control interface device and an image acquisition device comprised within a computer system according to one embodiment;

FIG. 3 illustrates an example of a motion control system having a PXI chassis including a computer card, motion control interface card, and measurement device according to one embodiment;

FIG. 4 illustrates an example application of the present invention in the field of robotics according to one embodiment;

FIG. 5 illustrates an example machine motion application where the goal is a fast procedure for precise alignment of two optical fibers according to one embodiment;

FIG. 6 illustrates a scanning system which utilizes continuous motion control and data acquisition triggering according to one embodiment; and

FIG. 7 is a flowchart illustrating a scanning method which utilizes continuous motion control and data acquisition triggering according to one embodiment.

While the invention is susceptible to various modifications and alternative forms, specific embodiments thereof are shown by way of example in the drawings and will herein be described in detail. It should be understood, however, that the drawing and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENT

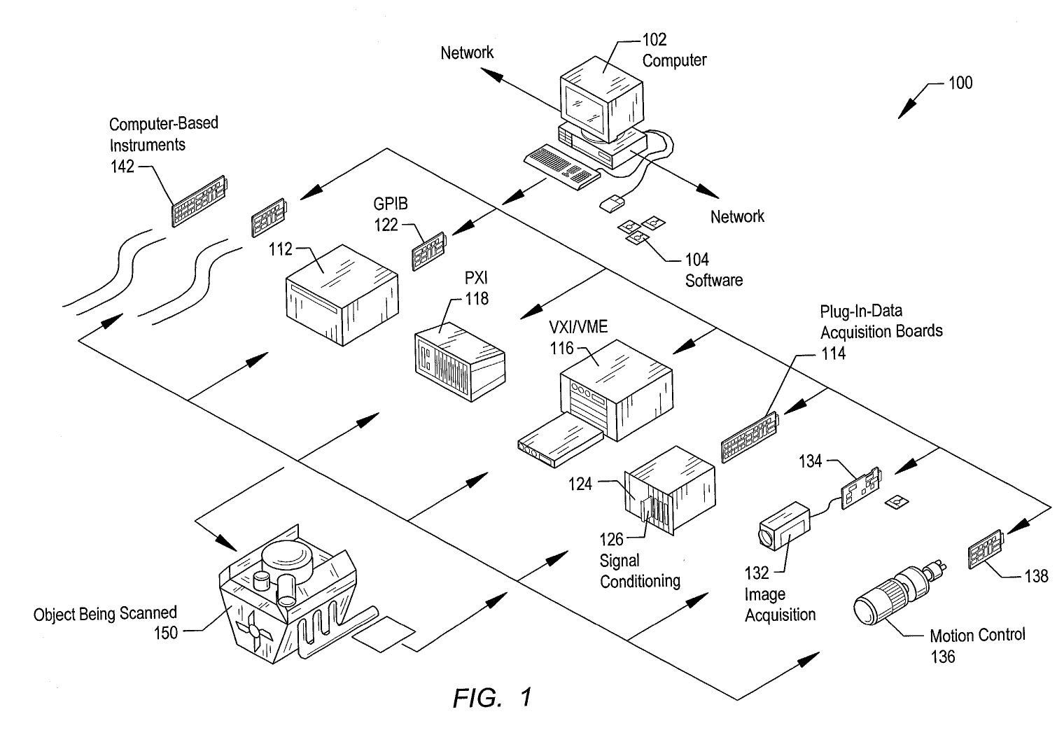

FIG. 1—Exemplary Motion Control/Measurement System

FIG. 1 illustrates an example measurement system or scanning system 100 that includes a motion control system and various options for measurement or data acquisition. System 100 may be used for general scanning of an object, or for precision alignment of two or more objects, such as alignment of two fiber optic cables. FIG. 1 is exemplary only, and the present invention may be used in any of various systems, as desired.

The system 100 comprises a host computer 102. The host computer 102 comprises a CPU, a display screen, memory, and one or more input devices such as a mouse or keyboard as shown. The computer 102 couples to a motion control system comprising a motion control device 136, also referred to as movement device 136, and a motion control interface device or card 138. The motion control device 136 or movement device 136 may be coupled to the computer 102 through the motion control interface device or card 138. For example, the motion control interface card 138 may be plugged in to an I/O slot in the computer 102, such as a PCI bus slot provided by the computer 102. However, the card 138 is shown external to computer 102 for illustrative purposes. The motion control interface device or card 138 may also be implemented as an external device coupled to the computer 102. The term “motion control device” is also used herein to refer collectively to the motion control device or movement device 136 and the motion control interface device 138.

The computer system 102 also couples to one or more measurement devices which may be used to acquire measurements of an object being scanned. The one or more measurement devices may include a GPIB instrument 112 and associated GPIB interface card 122, a data acquisition (DAQ) board 114 and associated signal conditioning circuitry 124, a VXI/VME instrument 116, a PXI instrument 118, a video device 132 and associated image acquisition card 134, and/or one or more computer based instrument cards 142, among other types of measurement or data acquisition devices.

The GPIB instrument 112 is coupled to the computer 102 via a GPIB interface card 122 provided by the computer 102. In a similar manner, the video device 132 is coupled to the computer 102 via the image acquisition card 134. The data acquisition board 114 is coupled to the computer 102, and optionally interfaces through signal conditioning circuitry 124 to the UUT. The signal conditioning circuitry 124 preferably comprises a SCXI (Signal Conditioning eXtensions for Instrumentation) chassis comprising one or more SCXI modules 126.

As described above with respect to the motion control interface card 138, the GPIB card 122, the image acquisition card 134, and the DAQ card 114 are typically plugged in to an I/O slot in the computer 102, such as a PCI bus slot provided by the computer 102. However, these cards 122, 134 and 114 are shown external to computer 102 for illustrative purposes. The cards 122, 134 and 114 may also be implemented as external devices coupled to the computer 102, such as through a serial bus.

The VXI/VME chassis or instrument 116 is coupled to the computer 102 via a serial bus, MXI bus, or other serial or parallel bus provided by the computer 102. The computer 102 preferably includes VXI interface logic, such as a VXI, MXI or GPIB interface card (not shown), which interfaces to the VXI chassis 116. The PXI chassis or instrument is preferably coupled to the computer 102 through the computer's PCI bus.

A serial instrument (not shown) may also be coupled to the computer 102 through a serial port, such as an RS-232 port, USB (Universal Serial bus) or IEEE 1394 or 1394.2 bus, provided by the computer 102.

In a typical measurement/scanning system, the motion control system, comprising motion control interface device 138 and motion control device 136, is integrated with one type of measurement device. For example, the motion control system may be integrated with a data acquisition device 114. Although not shown in FIG. 1, the motion control interface device 138 is preferably directly coupled with the measurement device through a dedicated channel to provide real time triggering and/or communication between the motion control interface device 138 and the measurement device.

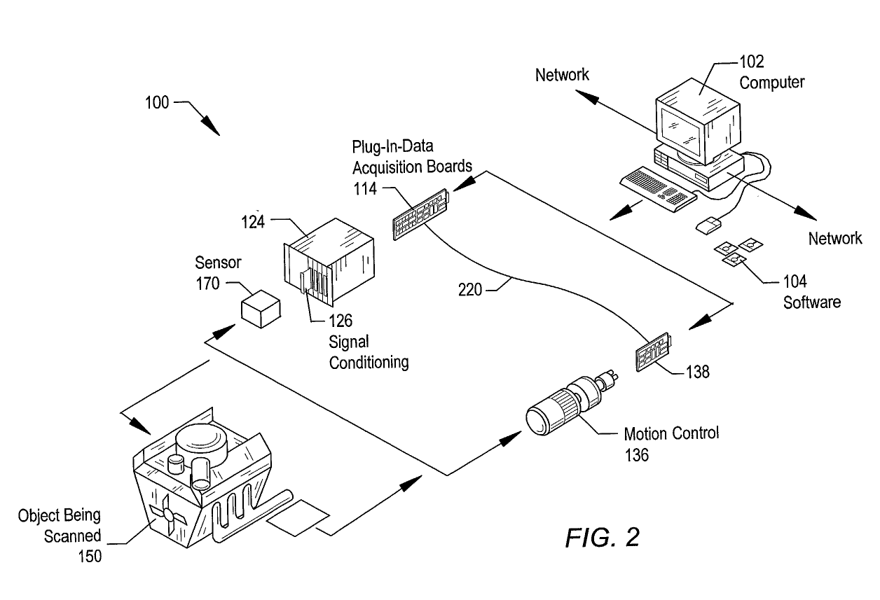

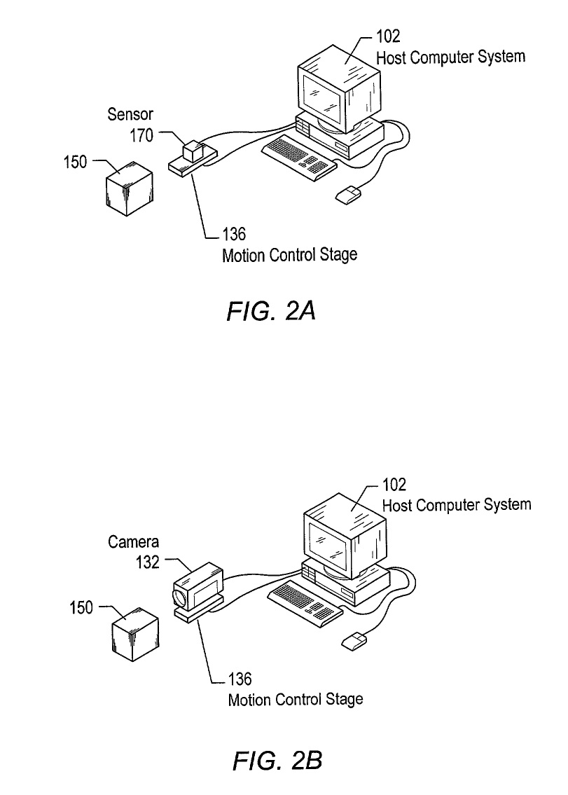

FIG. 2—Exemplary Motion Control System

FIG. 2 illustrates an example motion control system of FIG. 1, wherein the system includes motion control interface device 138 and a data acquisition device 114. The motion control interface device 138 may be coupled to cause movement of a sensor 170 to scan an object. The sensor 170 may be operable to acquire measurements of the object 150 being scanned. The data acquisition device 114 may be coupled to the sensor 170 to acquire data or measurements from the sensor 170.

As shown, the motion control interface device 138 is directly coupled with the measurement device through a dedicated channel to provide real time triggering and/or communication between the motion control interface device 138 and the data acquisition device 114. The computer 102 may operate to receive and integrate or correlate the position data and measurements received from the motion control interface card 138 and data acquisition device 114, respectively, as described below.

FIG. 2A illustrates an example motion control system wherein the motion control interface device 138 and data acquisition (or measurement) device 114 (not shown in FIG. 2A) are comprised in computer system 102. The motion control interface device 138 controls motion control stage 136, which moves sensor 170 relative to the object 150 being scanned. The data acquisition device 114 is operable acquire data sensed by the sensor 170.

FIG. 2B illustrates an example motion control system wherein the motion control interface device 138 and image acquisition (or measurement) device 134 (not shown in FIG. 2B) are comprised in computer system 102. The motion control interface device 138 controls motion control stage 136, which moves camera 132 relative to the object 150 being scanned. Here the camera 132 is simply one example of a sensor 170. The image acquisition device 134 is operable acquire data sensed by the camera 132.

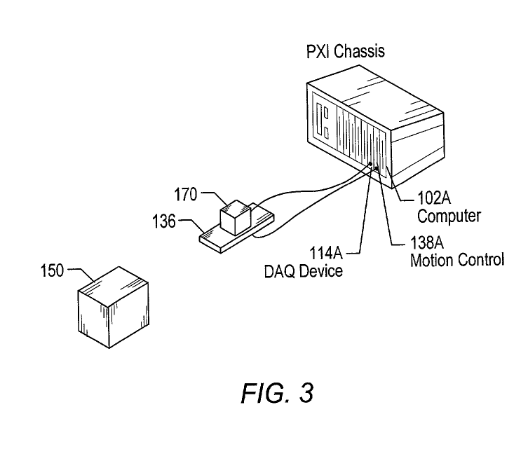

FIG. 3—Exemplary PXI-Based Motion Control System

FIG. 3 illustrates an example motion control system of FIG. 1, wherein the system includes a PXI chassis 118 comprising a computer card 102A, motion control interface card 138A and a measurement device, such as data acquisition device 114A. The motion control interface card 138A is similar to the motion control interface card 138, except that the motion control interface card 138A is in a PXI card form factor. Similarly, the data acquisition device 114A is similar to the data acquisition device 114, except that the data acquisition device 114A is in a PXI card form factor.

As described above with respect to FIG. 2, the motion control interface device 138A may be coupled to move a sensor 170 to scan an object. The sensor 170 may be operable to acquire measurements of the object 150 being scanned. The data acquisition device 114A may be coupled to the sensor 170 to acquire data or measurements from the sensor 170.

In this embodiment, the motion control interface device 138 is directly coupled with the measurement device through dedicated trigger and/or communication lines provided in the PXI backplane. Thus the PXI backplane provides real time triggering and/or communication between the motion control interface device 138A and the data acquisition device 114A. The computer or controller board 102A may be comprised in the PXI chassis to receive and integrate or correlate the position data and measurements received from the motion control interface card 138A and data acquisition device 114A, respectively, as described below.

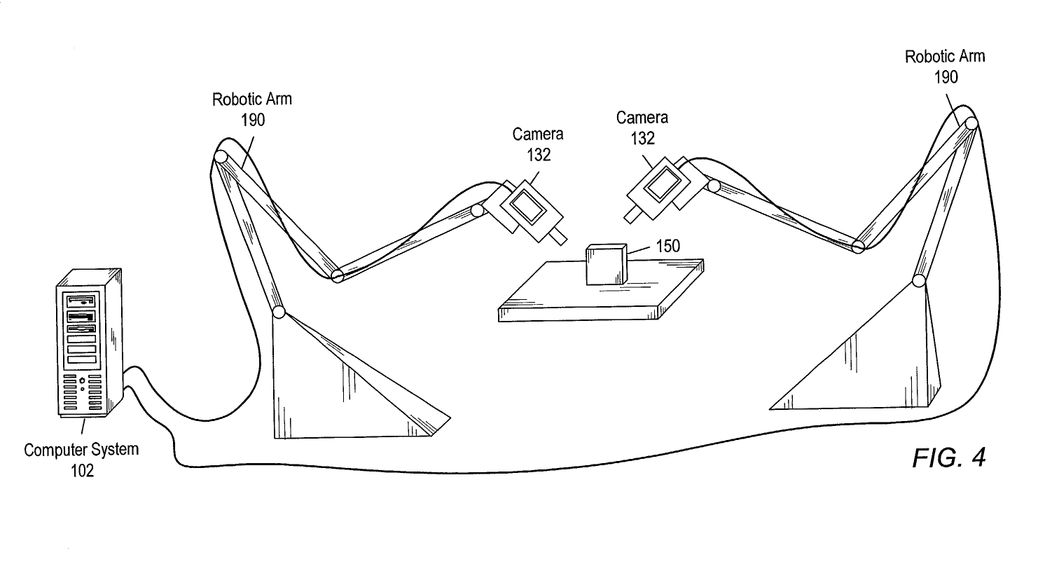

FIG. 4—Robotics Application of the Present Invention

FIG. 4 illustrates an example application of the present invention in the field of robotics. As FIG. 4 shows, a computer system 102 having a motion control system may be operable to control one or more robotic arms 190, each comprising a camera 110, to scan an object 150. The computer system 102 may be operable to store and execute software implementing a scanning scheme according to the present invention, as described further below. In one embodiment of the system shown in FIG. 4, multiple robotic arms may be used in tandem. In this case, a cooperative scanning strategy may be required which coordinates the movement of each arm 190 to collectively scan the object 150.

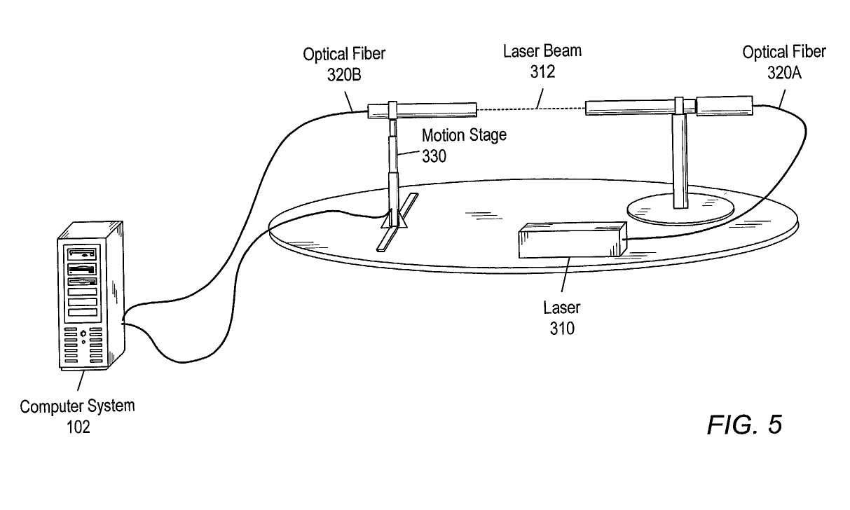

FIG. 5—Optical Fiber Alignment Application of the Present Invention

FIG. 5 illustrates an example machine motion application where the goal is a fast procedure for precise alignment of two optical fibers. In this example application, a laser source 310 generates a beam 312 which is routed into a first fiber 320A and checked or measured through a second fiber 320B. The intensity of the laser beam 312 is constantly measured and used to align the two fibers 320. Motion control stage 330 may be moved by a motion control system according to a scan pattern to align the two fibers 320A and 320B. This embodiment is described in greater detail below.

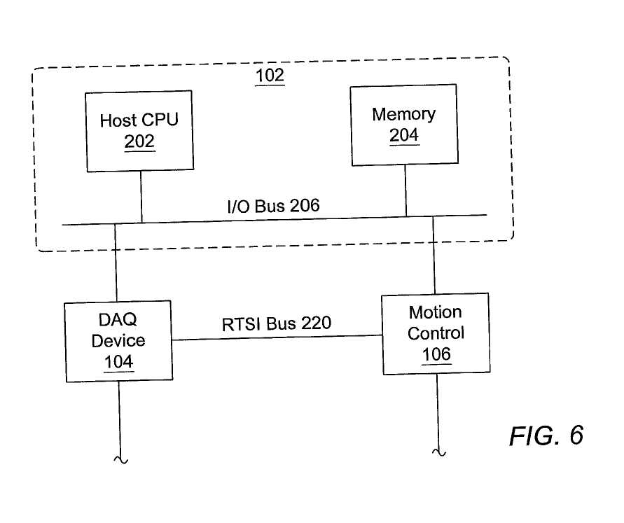

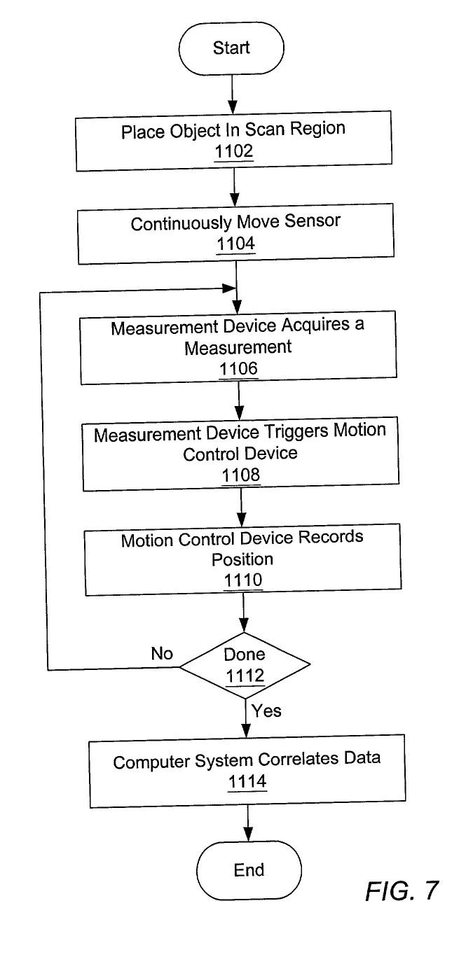

FIGS. 6 and 7—Scanning System and Method Which Utilize Continuous Motion Control and Data Acquisition Triggering

FIG. 6 illustrates a scanning system which utilizes continuous motion control and data acquisition triggering according to one embodiment. The system includes a computer system 102 that is coupled to a data acquisition device or card 104 and a motion control device or card 106. The computer system 102 may include a host CPU 202 and a memory 204 which are coupled to an I/O bus 206. A sensor may be coupled to the motion control device to acquire measurements of the object being scanned, wherein the sensor is also coupled to the data acquisition device to provide obtained measurements to the data acquisition device. In a precision alignment example, the motion control device may be coupled to move one or both of the objects being aligned, e.g., may be coupled to move one or both of two fiber optic components being aligned. A sensor may be coupled to one of the objects being aligned to acquire measurements of the relative alignment.

The data acquisition device and the motion control device are preferably directly coupled through a communication channel. For example, the computer system may include a data acquisition card and a motion control card which are connected through a real time system integration (RTSI) bus 220. In one embodiment, as illustrated in FIG. 3, the data acquisition card and the motion control card are comprised in a PXI chassis and utilize timing and triggering lines comprised in the PXI chassis for real-time communication. In this embodiment, the computer system may be an external system coupled to the PXI chassis, or a “computer on a card” comprised in the PXI chassis.

FIG. 7 is a flowchart illustrating a scanning method which utilizes continuous motion control and data acquisition triggering according to one embodiment. In 1102, an object 150 is placed in the scan region.

In various embodiments, other preparatory steps may include preparing the motion control board (e.g., card or device) to register positions based on an input trigger. Because the high-speed capture triggers may be occurring quickly (e.g., 50-100 Hz), an on-board buffer may be set up for storage until the host PC 102 can offload the values. Additionally, a scanning contour path may be generated and downloaded to the controller in whole or part. In one embodiment, this path may be arbitrary. Furthermore, a buffered hardware-timed power measurement may be set up. In one embodiment, two RTSI triggers may be used: (a) wait for a start trigger to come from the motion board, and (b) send the AI convert (e.g., scan clock) signal to the motion board.

In 1104, the motion control device preferably continuously moves the sensor to continuously scan the object of interest. The data acquisition device is operable to acquire data or measurements from an object being scanned, e.g., from the two or more elements being precisely aligned. For example, in a fiber optic precision alignment example, the data acquisition device may be coupled to a sensor which is adapted to measure the intensity of a light beam being generated by one of the fiber optic components in order to enable precision alignment of a second fiber optic component.

As the data acquisition device takes measurements of the object in 1106, the data acquisition device in 1108 also simultaneously generates a trigger over the communication channel to the motion control device when the measurements occur. In response to this trigger, in 1110 the motion control device records its position at substantially the exact time the data acquisition device acquired the measurement. For example, there may be a very small delay between the time that the data acquisition device acquires the measurement and the time the motion control device records its position. However, the speed of the motion control device relative to any delay may be such that the delay can be effectively ignored for the purposes of the scanning application.

Thus, the motion control device can operate continuously to move the sensor across the object being scanned (or move the object relative to the sensor), and when triggers are received the motion control device simply records its position. Thus, the data acquisition device records its measurements in a memory, and the motion control device records the corresponding positions of the sensor (or object) based on received triggers which correspond to when the measurements were taken. 1106 through 1110 may be performed repetitively (along with continuous motion of the sensor) until the desired amount of data has been gathered (said determination being shown in 1112). During these steps, the contour (path) buffer may be periodically refilled with pre-generated or dynamically generated position values.

In 1114, the computer system coupled to the data acquisition device and the motion control device may then receive the recorded measurements from the data acquisition device and the corresponding recorded positions from the motion control device and correlate this information to generate information regarding the measurements taken with respect to the positions recorded. This information can hence be used in various coarse and fine scanning patterns. For example, the information may be used to precisely align two objects such as two fiber optic components. This information can also be used to more efficiently scan an object for any of various features of interest.

Application of the System and Method to Alignment of Fiber-Optic Components

One application of the system and method disclosed herein may include the alignment of fiber-optic components, which is described as follows according to one embodiment. One general prior art strategy used to actively align fiber-optic components involves computerized control of micropositioning stages. The stage is guided to move in three, four, five, or six degrees of freedom based on optical power measurements or visual measurements using cameras. While the stage is at different locations in its search path, various measurements are made. Active alignment may comprise a “coarse scan” followed by a “fine scan.” The reason for this breakdown is due to the small area of light emitted from a single fiber relative to the initial search window. The purpose of a coarse scan is to couple any amount of light, and the purpose of the fine align is to discover the peak location in the beam profile. During coarse alignment, image acquisition and intelligent machine vision algorithms can be applied to visually determine a target position, or optical power can be measured at various positions to detect coupling efficiency and move to an aligned position. In either case, the fine alignment process using optical power measurements is preferably employed to achieve the highest resolution.

Current nano-positioning actuators include servo motors, stepper motors, linear motors, and piezo devices. Each of these actuator technologies have varying ranges of precision, travel range, maximum velocity, torque, and service life. In addition, mechanical variations such as lead screws, gear assemblies, cross roller bearings, and air bearings can affect specifications such as flatness, repeatability, backlash, and stick-slip. The desired hardware components may be chosen based on requirements for a particular fiber alignment system.

In a prototype of the system and method, mechanical hardware was chosen to deliver real-world specifications typical for the alignment of single-mode fiber. Single-mode fibers are used more in the telecommunications industry than multi-mode fibers, and they present a more challenging alignment resolution because the core diameter is less than 10 um. The specification for the prototype called for 50 nanometers of final resolution, 25 mm of travel along X, Y, and Z, 5 mm/sec velocity, 0.5ft-lb of torque, and 10000 hours of continuous operation (for manufacturing). The prototype used a servo-based stage from National Aperture using Renishaw linear encoders for feedback.

The initial search window for alignment can vary. For example, the range may vary from as close as a few hundred microns to as far as a few millimeters. Also called a blind search or scan, the goal of a course search is to detect “first light” in the least amount of time. Some prior art systems accomplish this by moving to a target position, making an optical power measurement, and repeating this process until first light is encountered. For example, a motion controller may command the motion, and an optical power meter may make the measurement. Thus, to perform a course scan in some prior art systems, the motion controller makes repeated point-to-point moves, and power is measured between each move while the mechanical system is not moving. Following the coarse alignment, any remaining axes or degrees of freedom can be fine aligned since some light has already been coupled.

The two most widely used coarse search paths are boustrophedon and rectangular spiral, which are well known to one skilled in the art. These paths are also called raster scanning and square spirals, respectively. Given a choice between these two search paths, a rectangular spiral is theoretically more advantageous in a blind search, because while both paths have the same average search time, the rectangular spiral has less variance (standard deviation.) In practice, the performance of a rectangular spiral may suffer slightly due to inertial settling problems, because it changes direction more frequently than a raster scan.

From an optical perspective, light emitted from a single fiber falls off in a Gaussian beam profile. Furthermore, manual pre-positioning inaccuracies are likely to have a circular probability distribution from an initial search location. Therefore, a circular spiral is generally a more efficient coarse scan path than raster or rectangular spiral. This type of motion requires a controller which can coordinate movement between multiple axes. Currently, automated systems which support this type of scan typically approximate a spiral movement by connecting line segments, resulting in some chordal error but moving measuring points near the circular spiral path. The Archimedes or equiangular spiral is a popular choice for evenly distributed sampling; however many other spiral search paths exist, such as logarithmic spirals for scans with greater density near the center.

While the existing scanning methods are adequate for accomplishing coarse alignment, there are better algorithms, currently undergoing development, which can decrease the average search time significantly even over a circular spiral.

Selecting an optimized coarse scan path can significantly reduce search times, perhaps by a factor of two or three times. However, the real bottleneck in current automated systems lies in the discrete measurement process. By understanding and overcoming the limitations of a discrete process, major performance gains may be realized using a synchronized and continuous alignment process.

There are several reasons why some prior art alignment systems are limited to a discrete process. For example, the motion control and power measurement components are often standalone units connected to a PC platform via a low performance bus such as serial (RS-232) or GPIB (IEEE-488). These communication buses are a poor choice for back-and-forth control and measurements and add overhead in the software driver layer as well as the physical layer.

Also, a real-time communications link does not connect standalone units, and most often there is no external synchronization or hardware triggering option. Thus, the actuator and mechanics must halt at each location to make a measurement rather than triggering a measurement of position and power during movement. Even a “move-stop-measure” approach without hardware triggering cannot guarantee true position measurements, because servo and closed-loop piezo actuators can jitter while settling to stop, and stepper motors can slip.

Finally, a continuous process also requires continuous motion through arbitrary paths such as a logarithmic spiral. Multiple axis contouring, which splines through arbitrary coordinates, is a feature which is supported on only a few high-end motion controllers in the marketplace.

The prototype alignment system employed the PCI bus for high bandwidth, the real time system integration (RTSI) bus for synchronization, and the PXI-7344 motion controller for contouring and high speed position registration. The PXI-6052E, a high-resolution 16-bit data acquisition board, was chosen to acquire hardware timed analog power levels from a Thorlabs optical power meter.

In most prior art applications, motor encoder signals or position breakpoints trigger data acquisition measurements. This is commonly called “position-based measurements” (as opposed to time-based measurements). The complexity in triggering measurements from an encoder signal arises from the need to gate the signal with a direction bit to avoid extra measurements, as well as accurately synchronize a start and stop trigger. Position breakpoints simplify the position-based measurement process at the expense of a lower triggering rate. Regardless, both encoder and breakpoint triggers are valid only on a single axis.

Instead, the prototype system used hardware clocked data acquisition measurements to trigger high-speed registration information via the RTSI bus. This allowed for the collection of “time-based, position-stamped measurements,” similarly as described above. Not only does this method allow one to continuously move and sample with synchronized measurements, but it also allows the collection of true correlated position data, including inertial or slip problems related to the mechanics. In one embodiment, this method of hardware synchronization allows for the measurement of approximately 100 synchronized measurements per second, e.g., compared to two to ten unsynchronized measurements per second over GPIB or RS-232. A coarse alignment time of fifteen minutes may thus be reduced to less than a minute using synchronization and continuous motion.

The fine alignment process in some prior art systems is also limited in performance by its algorithms and control and measurement hardware. The most commonly employed fine alignment is a dynamic process called “hill climb.” This algorithm is similar to the Newton-Rhapson method of iterative approximation, where point to point steps are taken along a single axis until power measurements decrease, then the step size is halved and the direction is reversed, and so on. The approach is mathematically naive because it only aligns a single axis at a time and is sensitive to certain types of noise, however it is reliable and achieves high final resolution. Improving the dynamic algorithms can help reduce fine alignment times. However, like the coarse process, the most dramatic improvements can be achieved through hardware improvements. The prototype system was able to perform hill climb using PCI-bus hardware in less than 10 seconds (compared to 60-90 seconds through GPIB).

Optimized search algorithms and continuous, synchronized measurements can reduce cycle times of automated alignment systems by over 10×. In a small number of applications where visual conditions are ideal, such as single fiber to fiber alignment, a machine vision based coarse alignment can also be applied. Machine vision algorithms for detecting fiber positions may be performed more quickly than the fastest optical power based alignment, because so much more information (pixels) can be acquired simultaneously.

Various embodiments may further include receiving or storing instructions and/or data implemented in accordance with the foregoing description upon a carrier medium. Suitable carrier media may include storage media or memory media such as magnetic or optical media, e.g., disk or CD-ROM, as well as transmission media or signals such as electrical, electromagnetic, or digital signals, conveyed via a communication medium such as network and/or a wireless link.

While the present invention has been described with reference to particular embodiments, it will be understood that the embodiments are illustrated and that the invention scope is not so limited. Any variations, modifications, additions and improvements to the embodiments described are possible. These variations, modifications, additions and improvements may fall within the scope of the invention as detailed within the following claims.

We claim:

1. A method for scanning an object, the method comprising:
continuously moving a motion control device, wherein said continuously moving the motion control device continuously moves one or more of a sensor and the object to allow the sensor to scan the object;
a measurement device periodically receiving measurement data from the sensor;
the measurement device triggering the motion control device each time measurement data is received, wherein the measurement device is directly coupled to the motion control device to allow direct communication between the measurement device and the motion control device; and
the motion control device recording its current position in response to each trigger by the measurement device.

2. The method of claim 1, further comprising:
a computer system receiving measurement data from the measurement device;
the computer system receiving position data from the motion control device; and
the computer system correlating the measurement data and the position data to determine scanning information for the object.

3. The method of claim 1,
wherein the measurement device is directly coupled to the motion control device through a dedicated channel to provide real-time triggering between the measurement device and the motion control device.

4. The method of claim 1,
wherein said measurement device triggering the motion control device each time measurement data is received comprises the measurement device triggering the motion control device simultaneously when the measurement data is received.

5. The method of claim 1,
wherein said motion control device recording its current position in response to each trigger by the measurement device comprises the motion control device recording the position of the motion control device at substantially the exact time as when the measurement device received the respective measurement data.

6. The method of claim 1,
wherein a motion stage is coupled to one or more of the sensor and the object;
wherein said motion control device continuously moving one or more of the sensor and the object comprises the motion control device continuously moving the motion stage;
wherein said motion control device recording its current position in response to each trigger by the measurement device comprises the motion control device recording a current position of the motion stage in response to each trigger by the measurement device.

7. The method of claim 1,
wherein the motion control device comprises a movement device and a motion control interface device;
wherein the measurement device is directly coupled to the motion control interface device to allow direct communication between the measurement device and the motion control interface device;
wherein said continuously moving the motion control device comprises the motion control interface device causing the movement device to move continuously;
wherein said measurement device triggering the motion control device each time measurement data is received comprises the measurement device triggering the motion control interface device each time measurement data is received;
wherein said motion control device recording its current position in response to each trigger by the measurement device comprises the motion control interface device recording a current position of the movement device in response to each trigger by the measurement device.

8. The method of claim 7, further comprising:
a computer system receiving measurement data from the measurement device; and
the computer system receiving position data from the motion control interface device;
wherein the motion control interface device comprises a first card coupled to the computer system.

9. The method of claim 8,
wherein the measurement device comprises a second card coupled to the computer system;
wherein the first card is directly coupled to the second card to allow direct communication between the first card and the second card.

10. The method of claim 9,
wherein the first card is directly coupled to the second card through a dedicated channel to provide real time triggering between the first card and the second card.

11. The method of claim 7, further comprising:
a computer system receiving measurement data from the measurement device; and
the computer system receiving position data from the motion control interface device;
wherein the motion control interface device is located externally to the computer system.

12. The method of claim 7,
a computer system receiving measurement data from the measurement device; and
the computer system receiving position data from the motion control interface device;
wherein the measurement device comprises a card coupled to the computer system.

13. The method of claim 7, further comprising:
a computer system receiving measurement data from the measurement device; and
the computer system receiving position data from the motion control interface device;
wherein the measurement device is located externally to the computer system.

14. The method of claim 7,
wherein the motion control interface device comprises a first PXI card included in a PXI chassis;
wherein the measurement device comprises a second PXI card included in the PXI chassis;
wherein the first card is directly coupled to the second card via a PXI backplane to allow direct communication between the measurement device and the motion control interface device.

15. The method of claim 14,
wherein the PXI chassis further includes a computer card;
wherein the method further comprises:
the computer card receiving measurement data from the second card;
the computer card receiving position data from the first card; and
the computer card correlating the measurement data and the position data to determine scanning information for the object.

16. The method of claim 1,
wherein said continuously moving one or more of a sensor and the object to allow the sensor to scan the object comprises continuously moving one or more of a sensor and a fiber optic cable to allow the sensor to acquire measurement data from the fiber optic cable;
wherein the method further comprises:
a computer system receiving measurement data from the measurement device;
the computer system receiving position data from the motion control device; and
the computer system correlating the measurement data and the position data to determine alignment information for the fiber optic cable.

17. The method of claim 1,
wherein the object comprises a first optical fiber;
wherein the method further comprises routing a laser beam through the first optical fiber;
wherein the sensor is operable to sense intensity of the laser beam through a second optical fiber;
wherein said measurement device periodically receiving measurement data from the sensor comprises the measurement device periodically receiving intensity measurement data from the sensor;
wherein the method further comprises correlating intensity measurement data received from the measurement device and position data received from the motion control device to align the first optical fiber and the second optical fiber.

18. The method of claim 1,
wherein the measurement device comprises a data acquisition device.

19. The method of claim 1,
wherein the sensor comprises a camera;
wherein said measurement device periodically receiving measurement data from the sensor comprises the measurement device periodically receiving visual data from the camera.

20. A method for scanning an object, the method comprising:
continuously moving a motion control device, wherein said continuously moving the motion control device continuously moves one or more of a sensor and the object to allow the sensor to scan the object;
a measurement device periodically receiving measurement data from the sensor;
the measurement device triggering a motion control device each time measurement data is received; and
the motion control device recording its current position in response to each trigger by the measurement device.

21. The method of claim 20,
wherein the measurement device is directly coupled to the motion control device to allow direct communication between the measurement device and the motion control device.

22. The method of claim 20, further comprising:
a computer system receiving measurement data from the measurement device;
the computer system receiving position data from the motion control device; and
the computer system correlating the measurement data and the position data to determine scanning information for the object.

23. A system for scanning an object, comprising:
a computer system;
a sensor for acquiring measurements of the object;
a motion stage coupled to one or more of the sensor and the object to move one or more of the sensor and the object to allow the sensor to scan the object;
a motion control device coupled to the motion stage for controlling movement of the motion stage, wherein the motion control device is operable to move the motion stage in a continuous fashion;
a measurement device coupled to the sensor for receiving measurements from the sensor;
wherein the measurement device is directly coupled to the motion control device to allow direct communication between the measurement device and the motion control device;
wherein the measurement device is operable to periodically take measurements of the object from the sensor, wherein the measurement device is operable to trigger the motion control device each time a measurement is taken;
wherein the motion control device is operable to record a position of the motion stage when a trigger is received from the measurement device;
wherein the computer system is operable to receive measurement data from the measurement device and position data from the motion control device and is operable to correlate the measurement data and the position data to determine scanning information for the object.

24. A system for scanning an object, comprising:
a device under test;
a sensor operable to sense characteristics of the device under test;
a chassis;
a measurement device housed in the chassis and coupled to the sensor, wherein the measurement device is operable to acquire measurement data from the sensor;
a motion control device housed in the chassis, wherein the motion control device is operable to continuously move one or more of the sensor and the device under test;
wherein the chassis includes a communication channel directly coupling the measurement device to the motion control device;
wherein the measurement device is operable to periodically acquire measurement data from the sensor, wherein the measurement device is operable to trigger the motion control device via the communication channel each time measurement data is acquired;
wherein the motion control device is operable to record a position of one or more of the sensor and the device under test in response to said measurement device triggering the motion control device via the communication channel each time measurement data is acquired.

25. The system of claim 24, further comprising:
a computer housed in the chassis;
wherein the computer is operable to receive measurement data from the measurement device and position data from the motion control device;
wherein the computer is operable to correlate the measurement data and the position data to determine scanning information for the object.

26. The system of claim 24, further comprising:
a computer system coupled to the measurement device and coupled to the motion control device;
wherein the computer system is operable to receive measurement data from the measurement device and position data from the motion control device;
wherein the computer system is operable to correlate the measurement data and the position data to determine scanning information for the object.

27. An automated method for aligning a first fiber optic cable to a second fiber optic cable, the method comprising:
routing a beam of light from the first fiber optic cable to the second fiber optic cable, wherein a sensor is operable to sense intensity of light emitted from the second fiber optic cable;
a motion control device continuously moving the first fiber optic cable relative to the second fiber optic cable, wherein said continuously moving the first fiber optic cable relative to the second fiber optic cable causes fluctuations in the intensity of light emitted from the second fiber optic cable;
a measurement device periodically acquiring measurement data from the sensor, wherein the measurement data is indicative of the intensity of light emitted from the second fiber optic cable;
the measurement device triggering the motion control device each time the measurement device acquires measurement data;
the motion control device recording its current position each time in response to said measurement device triggering the motion control device; and
correlating measurement data received from the measurement device and position data received from the motion control device to align the first fiber optic cable to the second fiber optic cable.

28. The method of claim 27,
wherein the measurement device is directly coupled to the motion control device to allow direct communication between the measurement device and the motion control device.
